(19) United States
(12) Patent Application Publication
(10) Pub. No.: US 2026/0188001 A1
(43) Pub. Date: Jul. 2, 2026

(54) IMAGE DEFECT DETECTION METHOD AND SYSTEM

(71) Applicant: ASUSTeK COMPUTER INC., Taipei (TW)

(72) Inventors: Wei-An Chen, Taipei (TW); Hsiu-Ting Yang, Taipei (TW); Chun-Hao Liao, Taipei (TW)

(21) Appl. No.: 19/419,692

(22) Filed: Dec. 15, 2025

(30) Foreign Application Priority Data
Jan. 2, 2025 (TW) 114100184

(51) Int. Cl. G06V 10/98; G06T 3/60; G06T 5/20; G06V 10/24; G06V 10/44; H04N 23/60

(52) U.S. Cl. CPC G06V 10/993; G06T 3/60; G06T 5/20; G06V 10/245; G06V 10/44; H04N 23/64; G06T 2207/20076

(57) ABSTRACT

An image defect detection method includes: photographing a standard color checker with a mask under different photography conditions to obtain a plurality of detection images; detecting a plurality of positioning marks on the detection image, and using the positioning marks to calculate an angle of image rotation; rotating the detection image by the angle in the reverse direction, and capturing a plurality of regions of interest in the detection image; calculating a plurality of preliminary edge positions at color boundaries in the regions of interest; removing a false positive position and a false negative position from the preliminary edge positions to obtain a plurality of final edge positions; calculating a standard deviation average and a number of out-of-bounds fluctuation peaks of the final edge positions; and filtering out, a defect edge region in each detection image that does not meet a standard.

### CROSS-REFERENCE TO RELATED APPLICATION

This application claims the priority benefit of Taiwan Application Serial No. 114100184, filed on Jan. 2, 2025. The entirety of the above-mentioned patent application is hereby incorporated by reference herein and made a part of specification.

### BACKGROUND OF THE INVENTION

### Field of the Invention

The disclosure relates to an image defect detection method and an image defect detection system in which a newly created chart for photography is used.

### Description of the Related Art

A high-order camera module mainly uses Quad Bayer arrangement and an interpolation algorithm (Remosaic) for image processing, to convert an image into a high-pixel photo with a Bayer structure. Quality of an image output by using the interpolation algorithm is affected by factors such as lens selection and module sensor settings, resulting in a possible edge defect in the output image.

However, in an image edge defect detection process, only a black chart and a white chart, such as a spatial frequency response chart (SFR chart), are used for image detection. As a result, an abnormal colored bevel edge is not discovered, and an interpolation algorithm-related problem is not discovered early in an initial disclosure phase. In addition, an existing detection tool does not include an algorithm that takes a colored bevel edge into account. As a result, even if relevant personnel find that the colored bevel edge is defective, there is no automated tool to quickly locate a problematic region, and there is no unified standard to measure the severity of the problem.

### BRIEF SUMMARY OF THE INVENTION

provides An image defect detection method is provided in the disclosure. The image defect detection method includes: photographing a standard color checker with a mask under different photography conditions to obtain a plurality of detection images, where the standard color checker with a mask includes a plurality of positioning marks; detecting a plurality of positioning marks on each detection image, and using the plurality of positioning marks to calculate an angle of image rotation; rotating the detection image by the angle in the reverse direction, and capturing a plurality of regions of interest in the detection image; calculating a plurality of preliminary edge positions at color boundaries in the regions of interest; removing a false positive position and a false negative position from the plurality of preliminary edge positions to obtain a plurality of final edge positions; calculating a standard deviation average and a number of out-of-bounds fluctuation peaks of the plurality of final edge positions; and filtering out, based on the standard deviation average and the number of out-of-bounds fluctuation peaks, a defect edge region in each detection image that does not meet a standard.

An image defect detection system is also provided in the disclosure. The image defect detection system includes a standard color checker with a mask, an image capture apparatus, and a computing apparatus. The standard color checker with a mask includes: a plurality of color blocks; a plurality of masks, where each of the plurality of masks is located in a middle region of each color block, to divide each color block into three sub-blocks; and a plurality of positioning marks, located outside the plurality of color blocks. The image capture apparatus photographs the standard color checker with a mask under different photography conditions to obtain a plurality of detection images. The computing apparatus is signal-connected to the image capture apparatus, to receive the plurality of detection images, where the computing apparatus performs defect detection on the detection images.

In conclusion, the disclosure provides an image defect detection method and system for detecting a quality problem of a colored bevel edge caused by an interpolation algorithm. In the disclosure, the standard color checker with a mask is used as a newly created chart and a new automated edge quality detection algorithm is combined to reduce a development risk of using a high-resolution lens in the future and improve detection efficiency. Therefore, the disclosure includes features such as standard quantification, objectivity, and immunity to an environmental influence, and greatly improves accuracy and efficiency of a detection process.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of an image defect detection system according to an embodiment of the disclosure;

FIG. 2 is a schematic diagram of a standard color checker with a mask used in an image defect detection system according to an embodiment of the disclosure;

FIG. 3 is a schematic diagram of an architecture in which an image defect detection system performs photography at a 15-degree angle according to an embodiment of the disclosure;

FIG. 4 is a schematic diagram of an architecture in which an image defect detection system performs photography at a 30-degree angle according to an embodiment of the disclosure;

FIG. 5 is a schematic diagram of an architecture in which an image defect detection system performs photography at a 45-degree angle according to an embodiment of the disclosure;

FIG. 6 is a schematic diagram of an architecture in which an image defect detection system performs photography at a short distance D1 according to an embodiment of the disclosure;

FIG. 7 is a schematic diagram of an architecture in which an image defect detection system performs photography at a distance D2 according to an embodiment of the disclosure;

FIG. 8 is a schematic diagram of an architecture in which an image defect detection system performs photography at a long distance D3 according to an embodiment of the disclosure;

FIG. 9 is a flowchart of an image defect detection method according to an embodiment of the disclosure;

FIG. 10 is a schematic diagram of an image defect detection method in which a detection image is rotated back to upright according to an embodiment of the disclosure;

FIG. 11 is a schematic image diagram of regions of interest and color boundaries generated by using an image defect detection method according to an embodiment of the disclosure;

FIG. 12 is a schematic diagram of an m*n matrix and sampled pixels generated by using an image defect detection method according to an embodiment of the disclosure;

FIG. 13 is a schematic diagram of an image defect detection method in which preliminary edge positions are calculated according to an embodiment of the disclosure;

FIG. 14 is a schematic diagram of an image defect detection method in which a false positive position and a false negative position are corrected according to an embodiment of the disclosure;

FIG. 15 is a schematic diagram of an image defect detection method in which a region average value and a standard deviation average of final edge positions are calculated according to an embodiment of the disclosure;

FIG. 16 is a schematic diagram of an image defect detection method in which a pixel average value is calculated according to an embodiment of the disclosure;

FIG. 17 is a schematic diagram of an image defect detection method in which a number of out-of-bounds fluctuation peaks is calculated according to an embodiment of the disclosure; and

FIG. 18 is a flowchart in which a defect edge region that does not meet a standard is filtered out based on a standard deviation average and a number of out-of-bounds fluctuation peaks according to an embodiment of the disclosure.

### DETAILED DESCRIPTION OF THE EMBODIMENTS

The following describes preferred embodiments in detail. However, the embodiments are only used for examples for description and are not intended to limit the scope of protection of the disclosure. In addition, in the embodiments, some elements are omitted from the drawings to clearly show the technical features of the disclosure. The same reference numerals in the drawings are used to represent the same or similar elements.

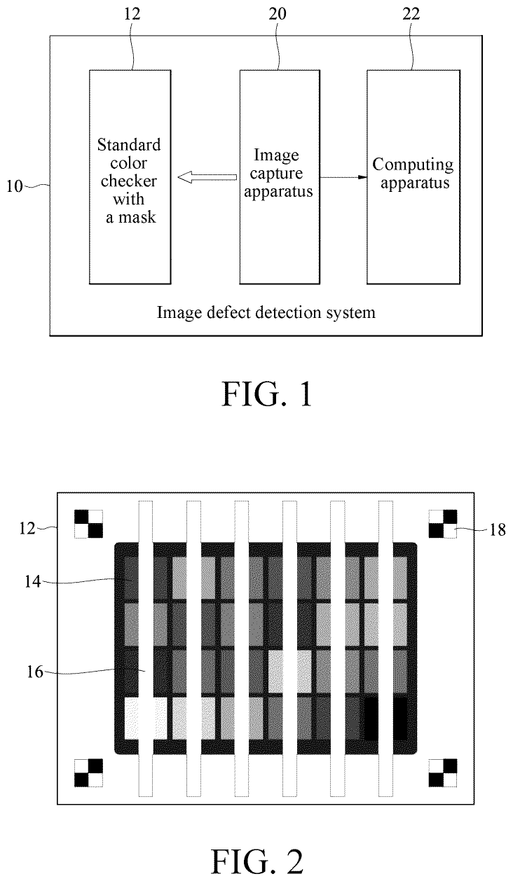

Refer to FIG. 1 and FIG. 2 simultaneously. An image defect detection system 10 includes a standard color checker 12 with a mask, an image capture apparatus 20, and a computing apparatus 22. The standard color checker 12 with a mask includes a plurality of color blocks 14, a plurality of masks 16, and a plurality of positioning marks 18. The plurality of color blocks 14 is arranged in a matrix. In this embodiment, the standard color checker 12 with a mask includes 24 color blocks 14 of different colors, arranged in a 4*6 matrix. Each of the plurality of masks 16 is located in a middle region of each color block 14 to divide each color block 14 into three sub-blocks, so that the color block 14 generates four color boundaries. In this embodiment, the mask 16 is a white mask, and a width of the mask 16 is one third of a width of the color block 14, so that the mask 16 is attached to a middle one-third position of each color block 14 (the middle region). The plurality of positioning marks 18 is located outside the color block 14 and are evenly arranged at four corners for image positioning. The positioning marks 18 are positioning points including black and white squares. The image capture apparatus 20 photographs the standard color checker 12 with a mask under different photography conditions to obtain a plurality of detection images. In an embodiment, the photography condition includes ambient light, a rotation angle, a zoom ratio, and a photography distance, to photograph the standard color checker 12 with a mask under the different photography conditions. The computing apparatus 22 is signal-connected to the image capture apparatus 20, to receive the plurality of detection images, so that the computing apparatus 22 performs defect detection on the detection images by using an algorithm.

In an embodiment, the image capture apparatus 20 is a mobile apparatus with a photographing function or an independently operated image capturing element, such as a camera or a video camera. The disclosure is not limited thereto. In this embodiment, a mobile apparatus (mobile phone) is directly used as the image capture apparatus 20 in the disclosure, and is collectively referred to as the image capture apparatus 20 below. In an embodiment, the computing apparatus 22 is an electronic device that independently performs computing, such as a personal computer, a notebook computer, or a tablet computer. The disclosure is not limited thereto.

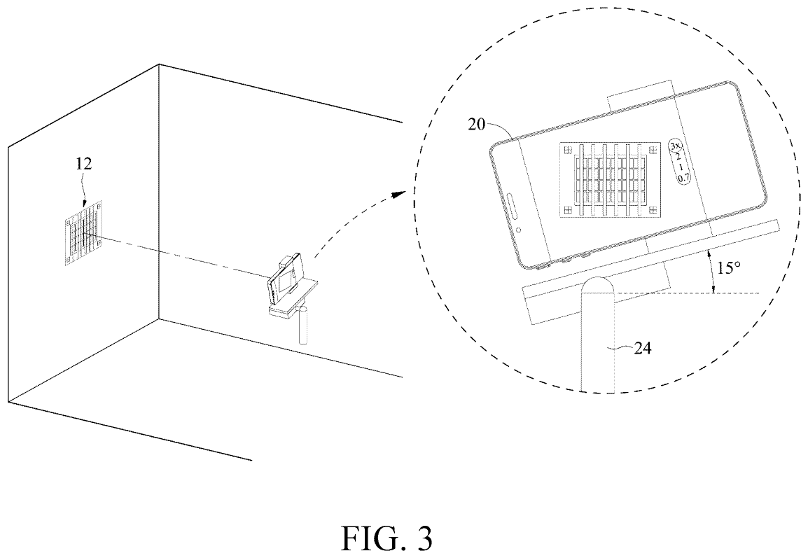

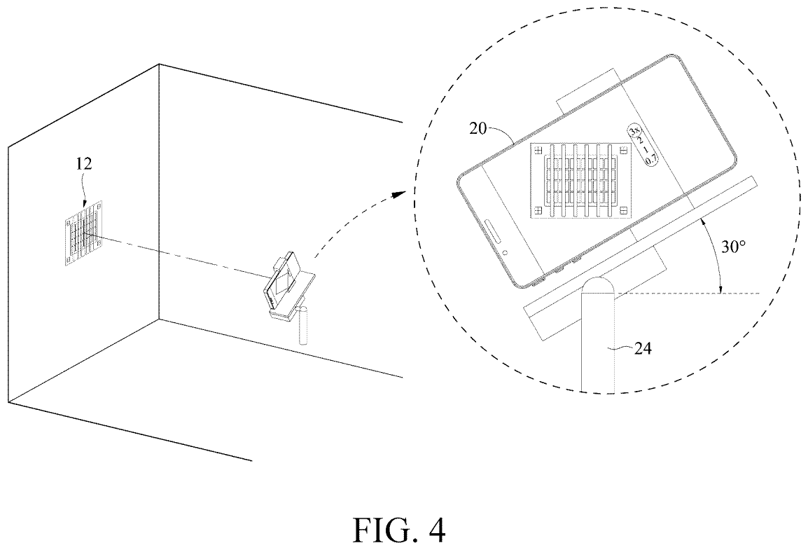

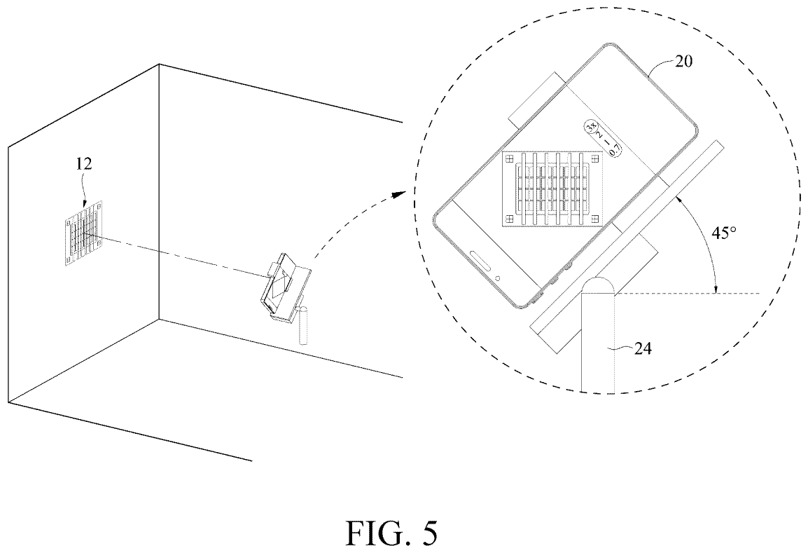

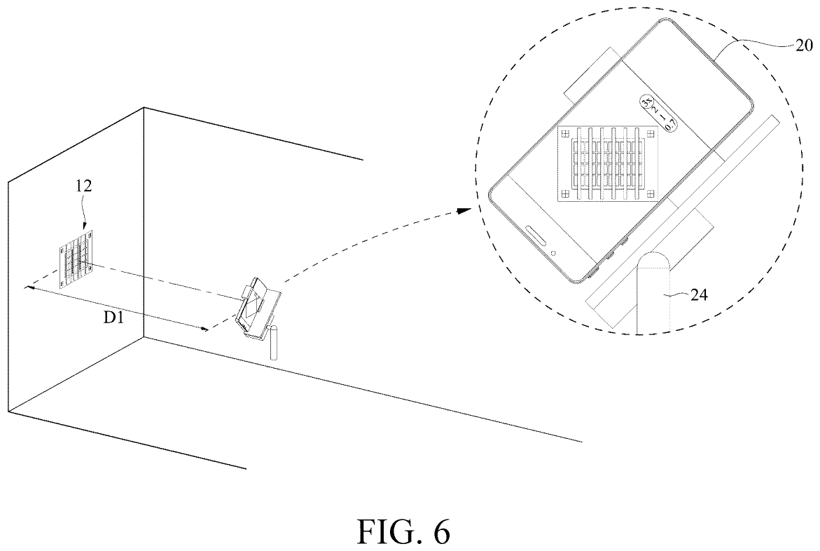

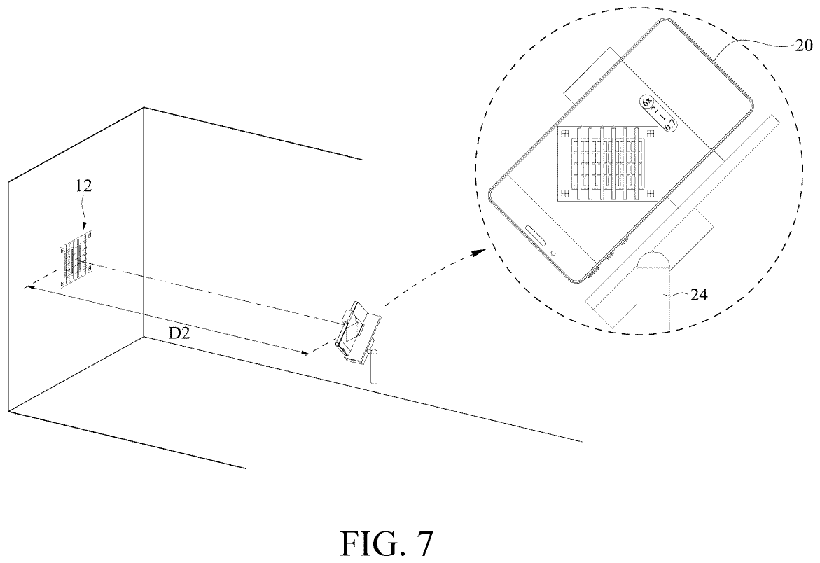

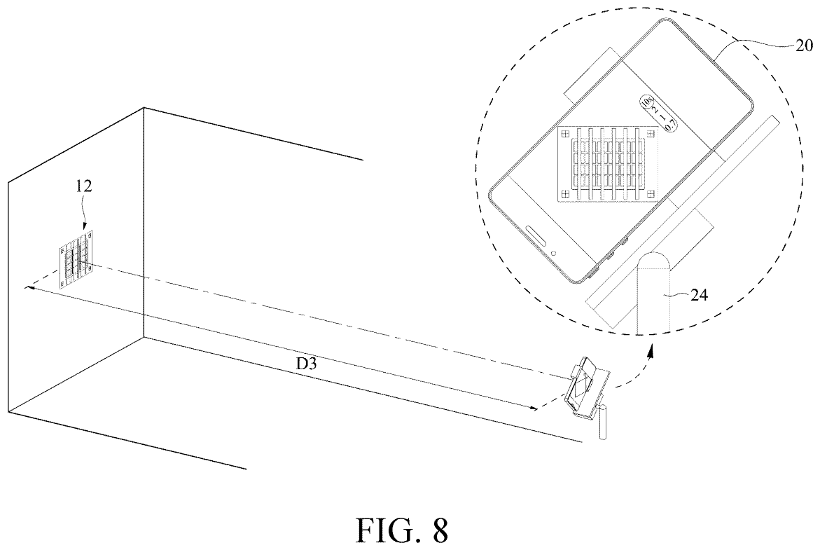

In an embodiment, refer to FIG. 1, FIG. 2, and FIG. 3 to FIG. 5 simultaneously. When the image capture apparatus 20 photographs the standard color checker 12 with a mask under the different photography conditions, the image capture apparatus 20 first verifies a scene requirement to set color temperature and brightness of ambient light, in an embodiment, D65 1000 lux. The image capture apparatus 20 is placed on a three-axis tripod 24 and rotated within a specific angle range. As shown in FIG. 3, a rotation angle is 15 degrees. As shown in FIG. 4, a rotation angle is 30 degrees. As shown in FIG. 5, a rotation angle is 45 degrees. Refer to FIG. 1, FIG. 2, and FIG. 6 to FIG. 8 simultaneously. When a lens ratio of the image capture apparatus 20 allows, in a visible range of a fixed image, the image capture apparatus 20 photographs the standard color checker 12 with a mask at different zoom ratios and different photography distances, and the zoom ratio is positively correlated with the photography distance. As shown in FIG. 6, under a condition of the rotation angle of 45 degrees, photography is performed on a short distance D1 by using a small zoom ratio, that is, a zoom ratio of 3×, and a photography distance is 10× centimeters. As shown in FIG. 7, photography is performed on a medium distance D2 by using a medium zoom ratio, that is, a zoom ratio of 6×, and a photography distance is 190 centimeters. As shown in FIG. 8, photography is performed on a long distance D3 by using a large zoom ratio, that is, a zoom ratio of 10×, and a photography distance is 310 centimeters. Next, an ambient light source is changed, and as described above, under a photography condition of changing the rotation angle, zoom ratio, and photography distance, the image capture apparatus 20 is caused to sequentially obtain the plurality of detection images.

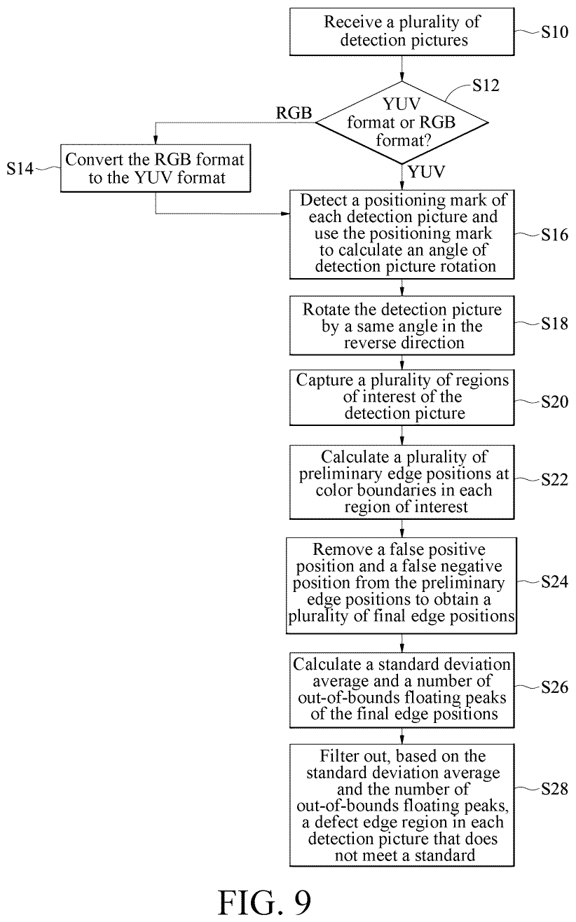

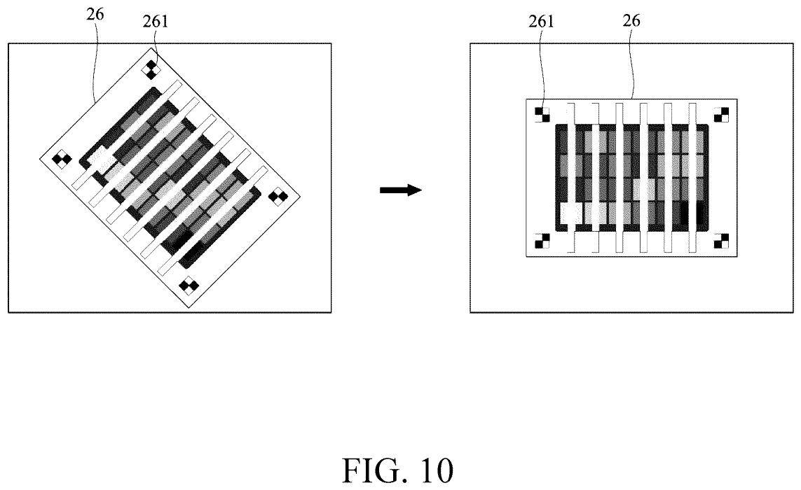

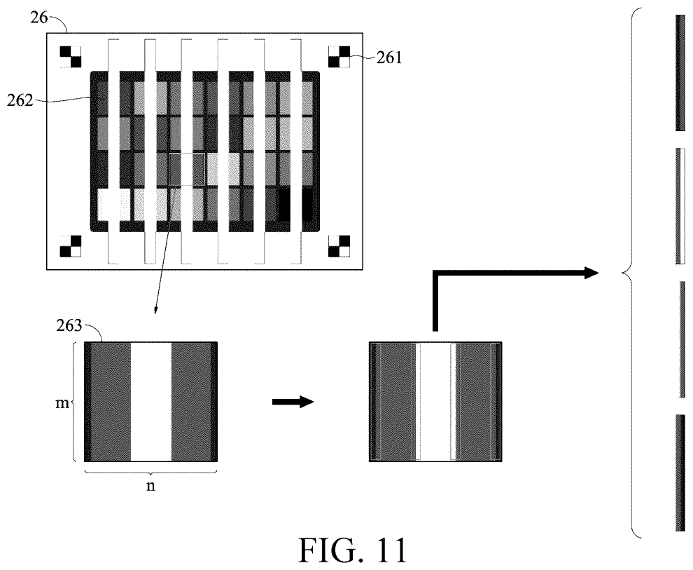

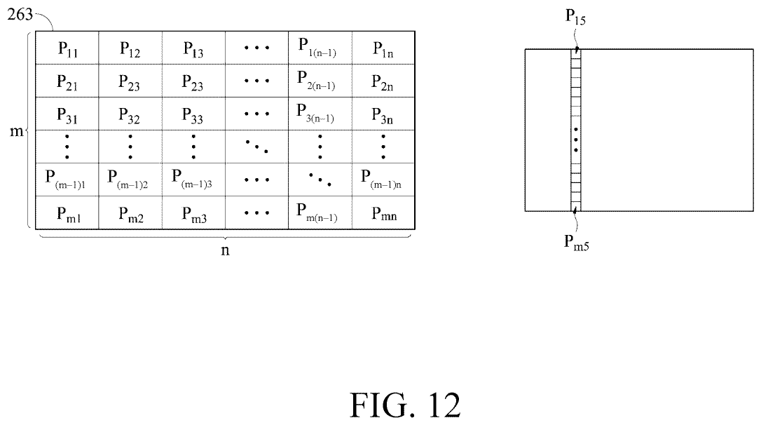

In the image defect detection system 10, after obtaining the detection images, the computing apparatus 22 performs an image defect detection method by using software. Refer to FIG. 1 and FIG. 9 simultaneously. As shown in step S10, the computing apparatus 22 receives the plurality of detection images from the image capture apparatus 20 and inputs the collected detection images into an algorithm in the computing apparatus 22. Because a format of an input image supports a YUV format and an RGB format, an image format is first determined after an input. As shown in step S12, the computing apparatus 22 determines whether the detection image is in the YUV format or the RGB format. If the detection image is in the YUV format, a next step S16 is continued to be performed. If the detection image is in the RGB format, as shown in step S14, the format of the detection image is first converted from the RGB format to the YUV format before a next step is continued to be performed. As shown in step S16 and FIG. 10, the computing apparatus 22 detects a plurality of positioning marks 261 at four corners of each detection image 26, and uses the positioning marks 261 to calculate an angle of rotation of the detection image 26. As shown in step S18, the computing apparatus 22 rotates the detection image 26 by a same angle in the reverse direction, to rotate the detection image 26 back to upright for subsequent calculation. After obtaining an upright detection image 26 obtained through rotation, as shown in step S20 and step S22, the computing apparatus 22 extracts a plurality of regions of interest (ROI) 263 of each color block image 262 in the detection image 26, as shown in FIG. 11. In this embodiment, corresponding to a number of color block images 262, a number of regions of interest 263 is also 24, to automatically select regions of interest 263 of 24 color blocks in a box manner. An example of a red color block is used, the region of interest 263 (color block image 262) is divided into three sub-blocks, including four color boundaries such as black-red, red-white, white-red, and red-black, to calculate a plurality of preliminary edge positions at color boundaries in each region of interest 263.

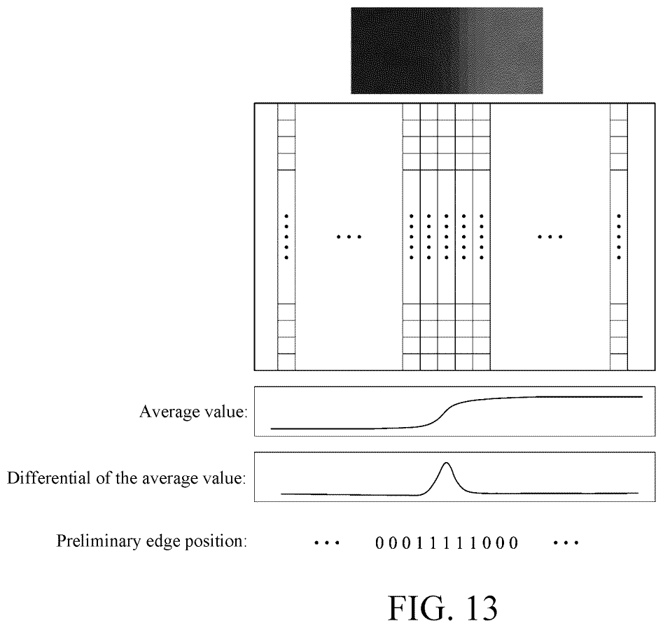

In an embodiment, the computing apparatus 22 further separates each region of interest 263 into three YUV channels to calculate each channel. When calculating the preliminary edge positions at color boundaries in the region of interest 263, reference is made to FIG. 11, FIG. 12, and FIG. 13 simultaneously. Each region of interest 263 includes m*n pixels. Average values of columns in the region of interest 263 of each channel are extracted and stored into an array. A 5^{th} column is used as an example, where sampling starts from a pixel P₁₅ and ends at a pixel Pₘ₅. Differentiation is performed on a curve of the array to calculate the plurality of preliminary edge positions by using the average value and a differential of the average value. If a node on the curve on which differentiation is performed exceeds a threshold, a column corresponding to the node is marked as the preliminary edge position, a mark 1 represents that there is an edge at a position of the column, and a mark 0 represents that there is no edge at the position of the column. FIG. 13 is used as an example, a red and black gradient at the top is a color boundary of real photos. Therefore, a plurality of preliminary edge positions marked as 1 is obtained at the color boundary.

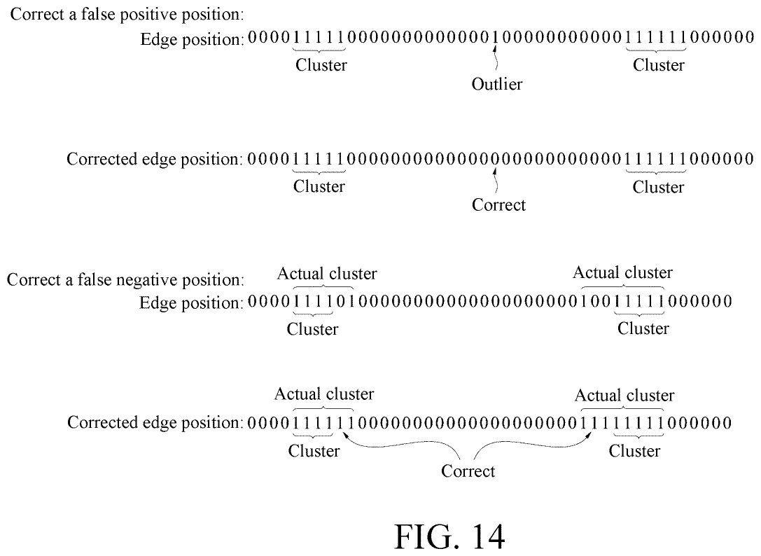

Next, to prevent factors such as noise, an edge defect, an inaccurate standard color checker photographing angle, or lens dirt from affecting subsequent calculation, the preliminary edge positions need to be corrected. As shown in step S24, a false positive position and a false negative position are removed from the preliminary edge positions to obtain a plurality of final edge positions. The false positive position is a position that is determined to be an edge but is not to be an edge, and the false negative position is a position that is determined to be a non-edge but is to be an edge. Refer to FIG. 14 simultaneously. When correcting the false positive position, the computing apparatus 22 uses a clustering method to correct the false positive position, and changes an outlier value marked as 1 to a correct value of 0. When correcting the false negative position, the clustering method is also continued to be used. If a number of 0s between independent Is near a type-1 cluster is less than a threshold, values marked as 0 are changed to 1. After correcting all false positive positions and false negative positions in the preliminary edge positions, the plurality of final edge positions is obtained.

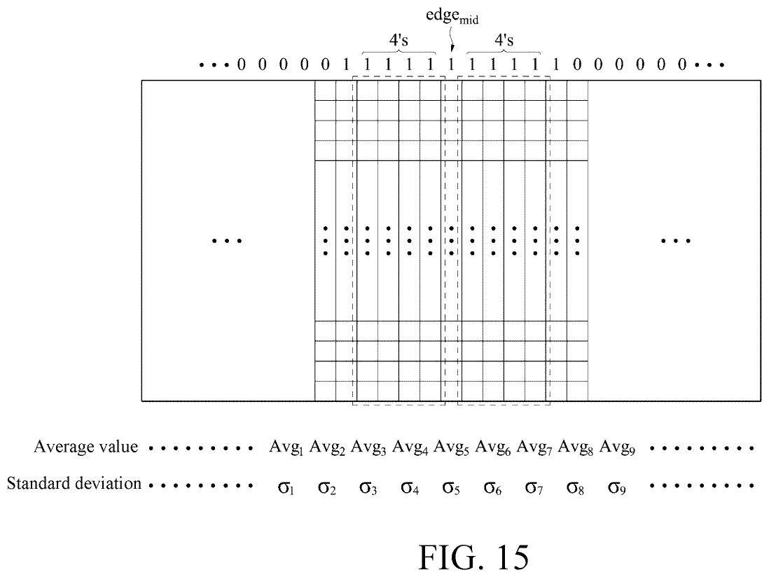

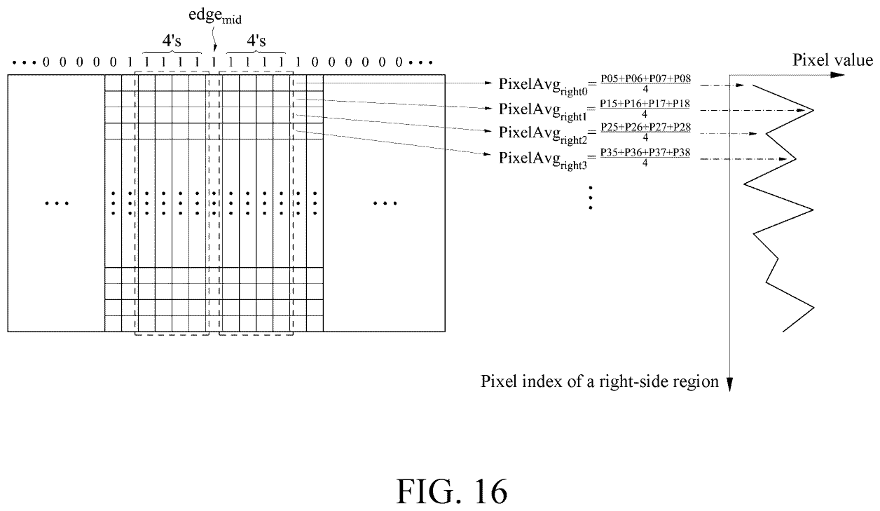

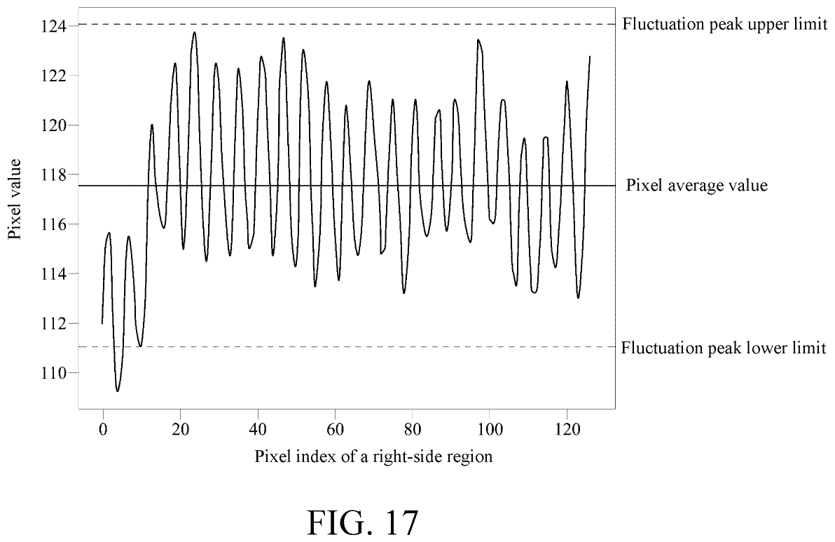

Next, as shown in step S26, a standard deviation average and a number of out-of-bounds fluctuation peaks of the final edge positions are calculated. Before obtaining the number of out-of-bounds fluctuation peaks, a region average value and the standard deviation average of the final edge positions are calculated first, and then the number of out-of-bounds fluctuation peaks is calculated based on the region average value. Specifically, after obtaining the final edge positions, the computing apparatus 22 calculates a number of edges (edgeCnt) of the final edge positions to find a final edge position (edge_{mid}) located at a middle position, as shown in equation (1). Each region of interest essentially includes four accurate final edge positions. Next, in the disclosure, defect diagnosis is performed on a region of each final edge position. As shown in FIG. 15, a region average value, a standard deviation average, and a number of out-of-bounds fluctuation peaks (Count_{fp}) are calculated for three channels (YUV) of a column at the final edge position. First, the final edge position (edge_{mid}) at the middle position is used as the reference, and the final edge position is divided into a left-side region and a right-side region. Column average values (Avgₐᵣₑₐ, that is Avg_{left} and Avg_{right}) of widths of four adjacent pixels are respectively calculated at a left side and a right side, as shown in equation (2) and equation (3), where pixel values at the left side and the right side are pᵤ and pᵢᵣ respectively. Then, averages of a sum of standard deviations of a single column are calculated, that is, standard deviation averages (σAvg_{left} and σAvg_{right}), as shown in equation (4) to equation (7). As shown in FIG. 16, a fluctuation peak refers to a curve obtained by connecting a pixel average value (PixelAvg) of vertical pixels of each group, where each group includes a pixel average value (PixelAvg) of every four horizontally adjacent pixels in a same region of the final edge position. Equation (8) is used to calculate a region average value (Avgₐᵣₑₐ). A upper bound and a lower bound of the fluctuation peak refer to thresholds defined by the region average value (Avgₐᵣₑₐ) combined with an offset (ΔD), which are recorded as a fluctuation peak upper limit (FPᵤₚₚₑᵣ) and a fluctuation peak lower limit (FP_{lower}), as shown in equation (9) and equation (10). As shown in FIG. 17, the computing apparatus 22 calculates the pixel average value (PixelAvg) of every four horizontally adjacent pixels in the same region of the final edge position. When the pixel average value exceeds the fluctuation peak upper limit or the fluctuation peak lower limit, it is determined to be out-of-bounds, and a number of out-of-bounds fluctuation peaks is increased by one to increase the number of exceeded fluctuation peaks, so that a number of out-of-bounds fluctuation peaks (Count_{fp}) is counted, as shown in equation (11) and equation (12).

$${edge}_{mid} = ⌊ \frac{edgeCnt}{2} ⌋ \qquad Equation ( 1 )$$

$${Avg}_{left} = \frac{1}{4 m} {\sum }_{l = {edge}_{mid} - 4}^{{edge}_{mid} - 1} {\sum }_{\text{?} = 1}^{m} {P}_{il} \qquad Equation ( 2 )$$

$${Avg}_{right} = \frac{1}{4 m} {\sum }_{r = {edge}_{mid} + 1}^{{edge}_{mid} + 4} {\sum }_{\text{?} = 1}^{m} {p}_{ir} \qquad Equation ( 3 )$$

$${σ}_{l} = \sqrt{\frac{1}{m} {\sum }_{i = 1}^{m} {( {p}_{i l} - {Avg}_{l} )}^{2}} , where {edge}_{mid} - 4 \leq l < {edge}_{mid} \qquad Equation ( 4 )$$

$${σ}_{r} = \sqrt{\frac{1}{m} {\sum }_{i = 1}^{m} {( {p}_{i r} - {Avg}_{r} )}^{2}} , where \qquad Equation ( 5 )$$

$${edge}_{mid} < r \leq {edge}_{mid} + 4$$

$$σ {Avg}_{left} = \frac{1}{4} {\sum }_{l = {edge}_{mid} - 4}^{{edge}_{mid} - 1} {σ}_{l} \qquad Equation ( 6 )$$

$$σ {Avg}_{right} = \frac{1}{4} {\sum }_{r = {edge}_{mid} + 1}^{{edge}_{mid} + 4} {σ}_{r} \qquad Equation ( 7 )$$

$${Avg}_{area} = \frac{1}{m} {\sum }_{i = 1}^{m} {PixelAvg}_{i} \qquad Equation ( 8 )$$

$${FP}_{upper} = {Avg}_{area} + Δ D \qquad Equation ( 9 )$$

$${FP}_{lower} = {Avg}_{area} + Δ D \qquad Equation ( 10 )$$

$$f ( i ) = \{ \begin{matrix}1 , & other \\ 0 , & {PixelAvg}_{i} > {FP}_{upper} or {PixelAvg}_{i} < {FP}_{lower}\end{matrix} \qquad Equation ( 11 )$$

$${Count}_{fp} = {\sum }_{i = 1}^{m} f ( i ) \qquad Equation ( 12 )$$

$$\text{?} \text{indicates text missing or illegible when filed}$$

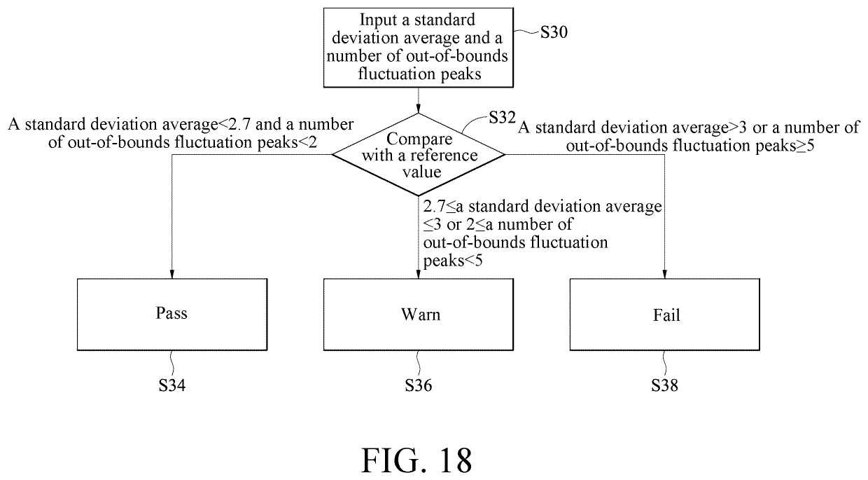

Finally, as shown in step S28, a defect edge region that does not meet a standard and that is in each detection image is filtered out based on the standard deviation average and the number of out-of-bounds fluctuation peaks. In an embodiment, the disclosure compares the calculated standard deviation average (σAvg) and the number of out-of-bounds fluctuation peaks (Count_{fp}) with a defined reference value to filter out the defect edge region that does not meet a standard. There are two types of defect edge regions that do not meet standards. One is a defect edge region with apparent defects, which is defined as “fail”; the other is a defect edge region with slight defects, which is defined as “warn”, for relevant personnel to further determine whether the defect edge regions are qualified. Therefore, when the defect edge region that does not meet a standard is filtered out from the detection image, the defect edge region that belongs to “fail” or “warn” is directly and separately marked to inform the relevant personnel. Refer to FIG. 1 and FIG. 18 simultaneously. As shown in step S30 and step S32, in the computing apparatus 22, an input of a determining formula is a standard deviation average and a number of out-of-bounds fluctuation peaks of a region, and is compared with the reference value. When the standard deviation average is less than 2.7 and the number of out-of-bounds fluctuation peaks is less than 2, as shown in step S34, the region is “pass” and represents a non-defect edge region. When 2.7≤a standard deviation average≤3 or 2≤a number of out-of-bounds fluctuation peaks<5, as long as one of the conditions is satisfied, as shown in step S36, the region is “warn” and represents that the region is a defect edge region with slight defects. When the standard deviation average is greater than 3 or the number of out-of-bounds fluctuation peaks is greater than or equal to 5, as long as one of the conditions is satisfied, as shown in step S38, the region is “fail” and represents that the region is a defect edge region with apparent defects. A numerical value of the reference value used above is used in an embodiment of the disclosure, is adjusted according to actual conditions, and is not be limited thereto.

Therefore, compared with a conventional edge defect detection method, the disclosure includes the following advantages: 1. The disclosure uses a standard color checker combined with a white mask, to observe performance of components with different brightness and color ratios in three YUV channels on an edge. However, in a conventional method, detection is performed on an edge only using a black-and-white image (in an embodiment, a spatial frequency response chart), which cannot account for performance of the three channels with different mixing ratios, making the conventional method less comprehensive than the disclosure. 2. Because pixels on a sensor in an image sensing apparatus are arranged horizontally and vertically, in the disclosure, oblique photography is performed at various angles to better verify interpolation performance of an interpolation algorithm (remosaic) on a bevel edge. However, in a conventional method, there is a problem of insufficient slope of a bevel edge, resulting in edge quality verification not being as close to a real scene as in the disclosure. 3. Use of a design of a standard color checker and a white mask overcomes a drawback of an original standard color checker that only allows for observation of a black edge, and provides more comprehensive observation of performance of the interpolation algorithm. 4. Conventionally, there is no detection method designed based on a newly created chart. Therefore, the only way is to check 24 color grids on the standard color checker by using manpower with naked eyes. The detection method in the disclosure automates a detection process, replaces manpower, and significantly shortens development time. 5. When using manpower to perform detection, individual standards for edge quality vary, and subjective opinions are inevitably added, resulting in reduced reliability. In the disclosure, statistical values are used to quantify a set of edge quality standards, so that fixed inputs generate a same result, thereby ensuring the reliability and stability of a detection process.

In conclusion, the disclosure provides an image defect detection method and system for detecting a quality problem of a colored bevel edge caused by an interpolation algorithm. In the disclosure, the standard color checker with a mask is used as a newly created chart and a new automated edge quality detection algorithm is combined to reduce a development risk of using a high-resolution lens in the future and improve detection efficiency. Therefore, the disclosure includes features such as standard quantification, objectivity, and immunity to an environmental influence, and greatly improves accuracy and efficiency of a detection process.

The embodiments described above are only for describing the technical ideas and features of the disclosure. The purpose is to enable a person skilled in the art to understand and implement the content of the disclosure accordingly. It is clear that the embodiments are not used to limit the scope of the patent in the disclosure, and any equivalent changes or modifications made according to the spirit disclosed in the disclosure are still be included in the scope of the patent application in the disclosure.

What is claimed is:

1. An image defect detection method, comprising:
photographing a standard color checker with a mask under different photography conditions to obtain a plurality of detection images, wherein the standard color checker with a mask comprises a plurality of positioning marks;
detecting a plurality of positioning marks on each detection image, and using the plurality of positioning marks to calculate an angle of image rotation;
rotating the detection image by the angle in the reverse direction, and capturing a plurality of regions of interest of the detection image;
calculating a plurality of preliminary edge positions at color boundaries in the plurality of regions of interest;
removing a false positive position and a false negative position from the plurality of preliminary edge positions to obtain a plurality of final edge positions;
calculating a standard deviation average and a number of out-of-bounds fluctuation peaks of the plurality of final edge positions; and
filtering out, based on the standard deviation average and the number of out-of-bounds fluctuation peaks, a defect edge region in each detection image that does not meet a standard.

2. The image defect detection method according to claim 1, wherein the photography condition comprises ambient light, a rotation angle, a zoom ratio, and a photography distance, to photograph the standard color checker with a mask under the different photography conditions.

3. The image defect detection method according to claim 2, wherein in a visual range of a fixed image, the standard color checker with a mask is photographed at different zoom ratios and different photography distances, and the zoom ratio is positively correlated with the photography distance.

4. The image defect detection method according to claim 1, wherein the standard color checker with a mask further comprises a plurality of color blocks and a plurality of masks, and each of the plurality of masks is located in a middle region of each color block, to divide each color block into three sub-blocks.

5. The image defect detection method according to claim 1, wherein a step of calculating the plurality of preliminary edge positions at the color boundaries in the plurality of regions of interest further comprises: extracting average values of columns in the plurality of regions of interest and storing the average values into an array, and performing differentiation on a curve of the array, to use the average value and a differential of the average value to calculate the plurality of preliminary edge positions.

6. The image defect detection method according to claim 5, wherein if a node on the curve on which differentiation is performed exceeds a threshold, a column corresponding to the node is marked as the preliminary edge position, a mark 1 represents that there is an edge at a position of the column, and a mark 0 represents that there is no edge at the position of the column.

7. The image defect detection method according to claim 1, wherein the false positive position is a position that is determined to be an edge but is not to be an edge, and the false negative position is a position that is determined to be a non-edge but is to be an edge.

8. The image defect detection method according to claim 7, wherein the false positive position and the false negative position are corrected by using a clustering method in the plurality of preliminary edge positions, to obtain the plurality of final edge positions.

9. The image defect detection method according to claim 1, wherein a step of calculating the standard deviation average and the number of out-of-bounds fluctuation peaks of the plurality of final edge positions further comprises: calculating a region average value and the standard deviation average of the plurality of final edge positions; and calculating the number of out-of-bounds fluctuation peaks based on the region average value.

10. The image defect detection method according to claim 9, wherein the region average value is combined with an offset to generate a fluctuation peak upper limit and a fluctuation peak lower limit, a pixel average value of every four horizontally adjacent pixels in a same region of the plurality of final edge positions is calculated, and when the pixel average value exceeds the fluctuation peak upper limit or the fluctuation peak lower limit, the number of out-of-bounds fluctuation peaks is increased to count a number of out-of-bounds fluctuation peaks.

11. An image defect detection system, comprising:
a standard color checker with a mask, wherein the standard color checker with a mask comprises:
a plurality of color blocks;
a plurality of masks, each located in a middle region of each color block, to divide each color block into three sub-blocks; and
a plurality of positioning marks, located outside the plurality of color blocks;
an image capture apparatus, photographing the standard color checker with a mask under different photography conditions to obtain a plurality of detection images; and
a computing apparatus, signal-connected to the image capture apparatus, to receive the plurality of detection images, wherein the computing apparatus performs defect detection on the plurality of detection images.

12. The image defect detection system according to claim 11, wherein a width of the mask is one third of a width of the color block.

13. The image defect detection system according to claim 11, wherein the mask is a white mask.

14. The image defect detection system according to claim 11, wherein the photography condition comprises ambient light, a rotation angle, a zoom ratio, and a photography distance, to photograph the standard color checker with a mask under the different photography conditions.

15. The image defect detection system according to claim 14, wherein in a visual range of a fixed image, the image capture apparatus photographs the standard color checker with a mask at different zoom ratios and different photography distances, and the zoom ratio is positively correlated with the photography distance.

16. The image defect detection system according to claim 11, wherein that the computing apparatus performs defect detection on the detection images further comprises: detecting a plurality of positioning marks on each detection image, and using the plurality of positioning marks to calculate an angle of image rotation; rotating the detection image by the angle in the reverse direction and capturing a plurality of regions of interest of the detection image; calculating a plurality of preliminary edge positions at color boundaries in the plurality of regions of interest; removing a false positive position and a false negative position from the plurality of preliminary edge positions to obtain a plurality of final edge positions; calculating a standard deviation average and a number of out-of-bounds fluctuation peaks of the plurality of final edge positions; and filtering out, based on the standard deviation average and the number of out-of-bounds fluctuation peaks, a defect edge region in each detection image that does not meet a standard.

17. The image defect detection system according to claim 16, wherein that the computing apparatus calculates the plurality of preliminary edge positions at the color boundaries in the plurality of regions of interest further comprises: extracting average values of columns in the plurality of regions of interest and storing the average values into an array, and performing differentiation on a curve of the array, to use the average value and a differential of the average value to calculate the plurality of preliminary edge positions.

18. The image defect detection system according to claim 17, wherein if a node on the curve on which differentiation is performed exceeds a threshold, a column corresponding to the node is marked as the preliminary edge position, a mark 1 represents that there is an edge at a position of the column, and a mark 0 represents that there is no edge at the position of the column.

19. The image defect detection system according to claim 16, wherein the false positive position is a position that is determined to be an edge but is not to be an edge, and the false negative position is a position that is determined to be a non-edge but is to be an edge.

20. The image defect detection system according to claim 19, wherein the computing apparatus corrects the false positive position and the false negative position by using a clustering method, to obtain the plurality of final edge positions.

21. The image defect detection system according to claim 16, wherein that the computing apparatus calculates a standard deviation average and a number of out-of-bounds fluctuation peaks of the plurality of final edge positions further comprises: calculating a region average value and the standard deviation average of the plurality of final edge positions; and calculating the number of out-of-bounds fluctuation peaks based on the region average value.

22. The image defect detection system according to claim 21, wherein the region average value is combined with an offset to generate a fluctuation peak upper limit and a fluctuation peak lower limit, the computing apparatus calculates a pixel average value of every four horizontally adjacent pixels in a same region of the plurality of final edge positions, and when the pixel average value exceeds the fluctuation peak upper limit or the fluctuation peak lower limit, the number of out-of-bounds fluctuation peaks is increased to count a number of out-of-bounds fluctuation peaks.
